(19) United States
(12) Patent Application Publication
(10) Pub. No.: US 2019/0099924 A1
(43) Pub. Date: Apr. 4, 2019

(54) REMOVABLE, REUSABLE MANDREL FOR PRODUCING BLADDERS FOR COMPOSITE COMPONENT MOLDING

(71) Applicant: HED CYCLING PRODUCTS, INC., Roseville, MN (US)

(72) Inventors: Christopher Andrew Edin, Mahtomedi, MN (US); Gregory Paul Alexander, Woodbury, MN (US)

(21) Appl. No.: 16/150,861

(22) Filed: Oct. 3, 2018

Related U.S. Application Data
(60) Provisional application No. 62/567,583, filed on Oct. 3, 2017.

(51) Int. Cl. B29C 33/50; B29C 43/36; B29C 70/44; B29C 70/34

(52) U.S. Cl. CPC B29C 33/505; B29C 43/3642; B29C 2043/3649; B29C 70/342; B29C 70/446

(57) ABSTRACT

A reusable mandrel for forming flexible molding bladders. The mandrel comprises a base adapted to form a bladder opening and a secondary mandrel piece coupled to the base to form a complex mandrel shape. The secondary mandrel piece is adapted to be removable from the base when within a bladder formed on the mandrel to allow the base and the secondary mandrel piece to be removed from the bladder through the bladder opening without damaging the bladder. The reusable mandrel is configurable in a non-removable and a removable configuration.

### RELATED APPLICATIONS

This application claims the benefit of priority under 35 U.S.C. § 119(e) to U.S. Provisional Patent Application No. 62/567,583, filed Oct. 3, 2017, entitled “Removable, Resuable Mandrel for Producing Bladders for Composite Component Molding,” by Edin, et al., which is hereby fully incorporated herein by reference for all purposes.

### TECHNICAL FIELD

This disclosure relates generally to flexible bladders used in the manufacture of composite components. In particular, this disclosure relates to mandrels used in producing such bladders. Even more specifically, the present disclosure is related to a pull-apart mandrel for composite bicycle component bladders.

### BACKGROUND

Composite materials (carbon fiber, fiberglass, etc.) have long been used to mold hollow or semi-hollow parts for various industries (sports equipment, aerospace, medical, etc.). These parts are traditionally molded within a fully or partially enclosed mold. In some molding process, the layered assembly of composite plies is simultaneously be pressurized against a mold surface and heated. Manufacturers often use internal bladders, pressurized with a working fluid, to push the composite material outward, forcing the laminate uncured part against the mold surfaces surrounding it.

The bladders used to assert internal pressure during molding are typically constructed of a flexible material such as neoprene or latex. The bladders are produced by dipping a relatively hard mandrel (e.g., formed of metal, wood, foam) into the liquid form of the bladder material to coat the mandrel, then allowing the bladder to cure into it's flexible, dry form while still on the mandrel. Although these bladders can stretch to accommodate some discrepancy between the bladder shape and the internal shape of a composite part, complications arise when the shapes vary by more than several millimeters along any given axis. Issues include: the bladder tearing on removing the bladder from the mold, the bladder blowing during molding (which yields a useless part), and non-uniform compression of the composite part (which yields cosmetic or structural defects).

Producing bladders to accommodate complicated shapes faces a number of challenges. Traditional one piece mandrels are limited in their geometry. For example, a one piece mandrel cannot form a bladder with an enclosed loop because the cured bladder can not be removed from the mandrel without destroying it. As another example, traditional methods cannot be used to form a bladder with extreme protrusions because the mandrel cannot be removed without tearing the bladder.

Several methods are used to form composite parts that include geometries for which a single traditional bladder cannot be constructed. For example, some composite part manufacturers use multiple bladders within one molded part. This is more expensive and complicated than a single bladder and can cause molding problems. Other composite part manufacturers split a composite part into multiple pieces for molding and subsequently bond them together. This is more complicated and time consuming than molding in a single piece. As another attempted solution, some manufacturers use bladders with soluble or destroyable cores (single use mandrels). Upon the bladder curing, the mandrel is destroyed and removed.

### SUMMARY

One embodiment described includes a reusable mandrel for forming flexible molding bladders. The mandrel comprises a base adapted to form a bladder opening and a secondary mandrel piece coupled to the base to form a complex mandrel shape. The secondary mandrel piece is adapted to be removable from the base when within a bladder formed on the mandrel to allow the base and the secondary mandrel piece to be removed from the bladder through the bladder opening without damaging the bladder. The reusable mandrel may be configurable in a non-removable configuration in which the mandrel cannot be removed from the bladder without damaging the bladder and a removable configuration in which the mandrel can be removed from the bladder without damaging the bladder. According to one embodiment, the base and the secondary mandrel piece form a below yield strength mandrel body.

The complex mandrel shape can comprise a variety of complex shapes including extreme protrusions and enclosed loops. According to yet another embodiment, the complex mandrel shape comprises a bicycle frame shape comprising protrusions extending in multiple directions. The secondary mandrel piece may be coupled to the base in a variety of manners including by magnets, geometric features, mechanical fasteners or other mechanisms. According to one embodiment, the base defines a first fastener opening and the secondary mandrel piece defines a second fastener opening aligned with the first fastener opening. The mandrel further comprises a mechanical fastener running from the first fastener opening to the second fastener opening.

Another embodiment includes a method of forming a flexible molding bladder. According to one embodiment, the method includes dipping a reusable mandrel in a bladder material, the reusable mandrel comprising a base adapted to form a bladder opening a secondary mandrel piece removably coupled to the base to form a complex mandrel shape. The method can further include at least partially curing the bladder material on the mandrel to form a first flexible bladder on the mandrel. The method can further include reconfiguring the reusable mandrel from a non-removable configuration to a removable configuration by, for example, removing the secondary mandrel piece from the base while the secondary mandrel piece is within the first flexible bladder formed on the mandrel. The method can further include removing the base and the secondary mandrel piece from the first flexible bladder, reassembling the first mandrel for reuse to form another flexible bladder. According to one embodiment, at least partially curing the bladder material to form a first flexible bladder on the mandrel comprises forming a first flexible bladder having a bicycle frame shape.

According to one embodiment, removing the secondary mandrel piece from the base while the secondary mandrel piece is within the first flexible bladder formed on the mandrel comprises manipulating the secondary mandrel piece to overcome a magnetic force or a friction force of geometric features. Removing the secondary mandrel piece from the base while the secondary mandrel piece is within the first flexible bladder formed on the mandrel may also include manipulating a mechanical fastener from outside of the first flexible bladder to release the secondary mandrel piece from the base.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of one embodiment of a mandrel and bladder;

FIG. 2A is a front view of one embodiment of an apparatus for shaping a bladder;

FIG. 2B is top view of one embodiment of an apparatus for shaping a bladder;

FIG. 2C is a cross-sectional view one embodiment of an apparatus for shaping a bladder;

FIG. 2D illustrates one embodiment of disassembling one embodiment of an apparatus for shaping a bladder;

FIG. 3A is a front view of a second embodiment of an apparatus for shaping a bladder;

FIG. 3B is a cross-section of the second embodiment of an apparatus for shaping a bladder;

FIG. 3C is top view of the second embodiment of an apparatus for shaping a bladder;

FIG. 3D is a cross-sectional view of the second embodiment of an apparatus for shaping a bladder;

FIG. 3E illustrates one embodiment of disassembling the second embodiment of an apparatus for shaping a bladder;

FIG. 4A is a front view of a third embodiment of an apparatus for shaping a bladder;

FIG. 4B is a top view of the third embodiment of an apparatus for shaping a bladder;

FIG. 4C is a cross-sectional view of the third embodiment of an apparatus for shaping a bladder;

FIG. 4D illustrates one embodiment of disassembling the third embodiment of an apparatus for shaping a bladder;

FIG. 5 illustrates one embodiment of a mandrel and a bladder formed thereon;

FIG. 6A illustrates a front view of one embodiment of a mandrel for forming a bladder with an enclosed loop;

FIG. 6B illustrates a top view of one embodiment of a mandrel for forming a bladder with an enclosed loop;

FIG. 6C illustrates a cross-sectional view of one embodiment of a mandrel for forming a bladder with an enclosed loop;

FIG. 6D illustrates one embodiment of a mandrel for forming a bladder with an enclosed loop being disassembled;

FIG. 6E illustrates one embodiment of a mandrel for forming a bladder with an enclosed loop being further disassembled;

FIG. 7 illustrates one embodiment of a bladder having a bicycle frame shape;

FIG. 8A illustrates a first view of one embodiment of a mandrel that can be used to form a bladder with a bicycle frame shape;

FIG. 8B illustrates a second view of one embodiment of a mandrel that can be used to form a bladder with a bicycle frame shape;

FIG. 8C illustrates a third view one embodiment of a mandrel that can be used to form a bladder with a bicycle frame shape;

FIG. 8D illustrates a cross-sectional view one embodiment of a mandrel that can be used to form a bladder with a bicycle frame shape;

FIG. 8E illustrates one embodiment one embodiment of a mandrel that can be used to form a bladder with a bicycle frame shape in a first state of disassembly; and

FIG. 8F illustrates one embodiment of a mandrel that can be used to form a bladder with a bicycle frame shape in a second state of disassembly.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

For purpose of this disclosure, “damaging” a bladder and “rendering a bladder unusable” refers to damaging the bladder such that the bladder is unusable for use in an intended composite component molding operation (or other intended purpose). A “removable mandrel” refers to the capability to remove the mandrel from within the bladder without rendering a bladder formed on the mandrel unusable. A “reusable mandrel” refers to a mandrel that can be used to produce multiple usable bladders. In some cases, a reusable mandrel may include some consumables, such as shear pins, that are replaced when the mandrel is reassembled; however the large majority of the mandrel is reusable. A “below yield strength mandrel” refers to a mandrel that can be disassembled and removed from a flexible bladder formed on the mandrel without exceeding the yield strength of the bladder material with which the mandrel is used. According to one embodiment, a below yield strength mandrel may have a first “non-removable” configuration (e.g., a fully assembled configuration) that would damage the bladder if the mandrel were removed in that configuration and a below yield strength or “removable” configuration that allows removal of the mandrel without damaging the bladder. An “extreme protrusion” refers to a protrusion on a mandrel that would render a bladder formed on the mandrel unusable if the mandrel were to be removed from the bladder without reconfiguration. A “complex shape” refers to a shape for a bladder that requires a mandrel to reconfigured so that the mandrel can be removed from the bladder without damaging or rendering the bladder unusable (an identical bladder could not be created on and removed from a single-piece mandrel without rendering the bladder unusable or destroying the single piece mandrel).

According to one embodiment, a mandrel comprises a mandrel body formed of multiple pieces that are assembled together. The pieces may be held together using geometry features (mortise and tenons, keyways and other features), mechanical fasteners (screws, nails, bolts, set screws or other fasteners), magnets, spring loaded detent or pin and receiving indent or other releasable holding mechanism. A bladder is dipped and cured with all the pieces assembled together. Upon full cure, the pieces within the bladder can be disassembled from outside the bladder and removed via one or more openings in the bladder. For example, the pieces of the mandrel may be pulled apart, in some cases after the release of a locking device, and the pieces manipulated out of an opening left by the mandrel in the cured bladder. The number, sizes, shapes of mandrel pieces can be based on the size of the opening, the flexibility of the material and other factors. Once the bladder is free from its mandrel pieces, the mandrel can be reassembled and reused.

In accordance with one aspect of the present disclosure, a mandrel includes a base piece—which may be formed of one or more pieces—that extends out of an opening in a bladder after the bladder has been dipped. The base piece is adapted to form the bladder opening. One or more secondary mandrel pieces are removably coupled to the base piece. One or more additional secondary mandrel pieces may be coupled to other secondary mandrel pieces. The mandrel pieces are coupled together using releasable holding mechanisms adapted to hold the mandrel pieces together during dipping and curing, but allow the mandrel to be at least partially disassembled in the bladder and removed from the bladder through the opening formed by the base piece without rendering the bladder unusable for composite component molding operations. The mandrel pieces are adapted to be manipulated in the bladder and fit through the opening in the bladder, in some cases, when manipulated in a particular sequence, without rendering the bladder unusable for composite component molding operations.

The size and shape of the base piece and secondary pieces and the amount of movement required to disassemble the mandrel and remove the mandrel pieces is selected to be within the stretchability of the bladder so that the base piece and secondary pieces can be removed without damaging the bladder. For example, the mandrel pieces may be shaped, sized, joined together and otherwise adapted so that disassembly of the mandrel does not require exceeding the yield strength of a bladder formed using the mandrel and the mandrel may be removed from the bladder in multiple pieces without damaging the bladder. In another embodiment, the mandrel pieces may be shaped, sized, joined together and otherwise adapted so that disassembly of the mandrel does not require exceeding the ultimate strength of a bladder formed using the mandrel and the mandrel may be removed from the bladder in multiple pieces without rendering the bladder unusable. In yet another embodiment, the mandrel pieces may be shaped, sized, joined together and otherwise adapted so that disassembly of the mandrel may cause some necking of the bladder material, but does not cause fracture nor render the bladder unusable. As the skilled artisan will appreciate, the configuration of mandrel pieces may depend on the shape of the mandrel and the elasticity of the bladder material.

Secondary mandrel pieces may be coupled to the base piece or other secondary mandrel pieces using a variety of releasable holding mechanisms. In accordance with one embodiment, two or more mandrel pieces may be connected using magnetic force. A mandrel piece may be formed of a magnetic material or contain magnets and another mandrel piece may be formed of a magnetic material or contain magnets such that the two mandrel pieces may be held together during dipping of the mandrel and curing of the bladder. In accordance with another embodiment, two or more mandrel pieces may be connected using a mortise-tenon joint or other geometry features. In accordance with yet another embodiment, two or more mandrel pieces may be connected using a releasable locking device, such as a releasable mechanical fastener.

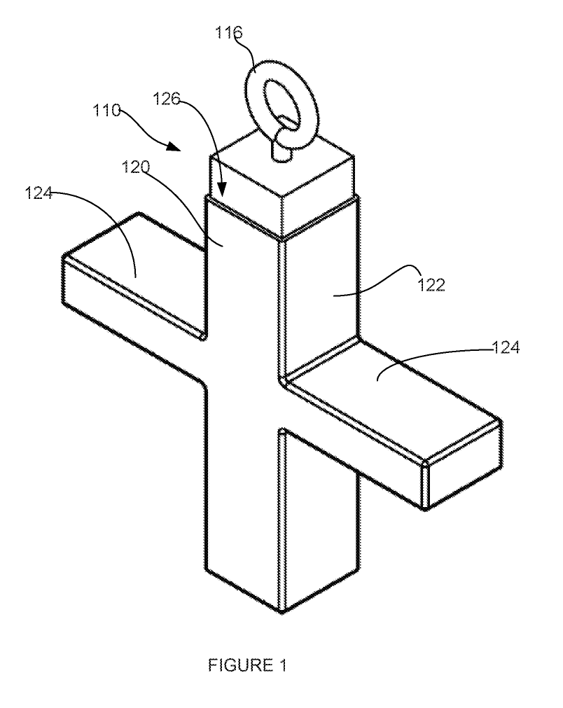

FIG. 1 illustrates one embodiment of an apparatus comprising a mandrel 110 in a bladder 120. Mandrel 100 has a cross-shaped mandrel body that includes a center portion to form a center portion 122 of bladder 120 and mandrel body arms to form arms 124 of bladder 120. The mandrel body is coupled to a hanging feature 116 so that mandrel 100 can be held by a tool.

In operation, mandrel 110 is dipped into a tank of liquid bladder material and then removed. Residual material dries on mandrel 100 and forms flexible bladder 120 with an opening 126 at top. In order to remove bladder 120 from mandrel 110, mandrel 110 must pass through opening 126. If mandrel 110 has a one-piece mandrel body, the bladder materials that are typically used to make bladders for composite part manufacturing would be insufficiently stretchable to allow removal of mandrel 110 without damaging bladder 120. In particular, the bladder 120 would be insufficiently stretchable to allow removal of the arms portion. As such, if mandrel 110 has a one-piece mandrel body, bladder 120 cannot be removed from mandrel body 110 without ripping bladder 120 or destroying the mandrel 110. Embodiments described herein, however, provide mandrels that can be disassembled for removal and reassembled for subsequent use. In particular, certain embodiments provide removable, reusable mandrels for complex bladder shapes.

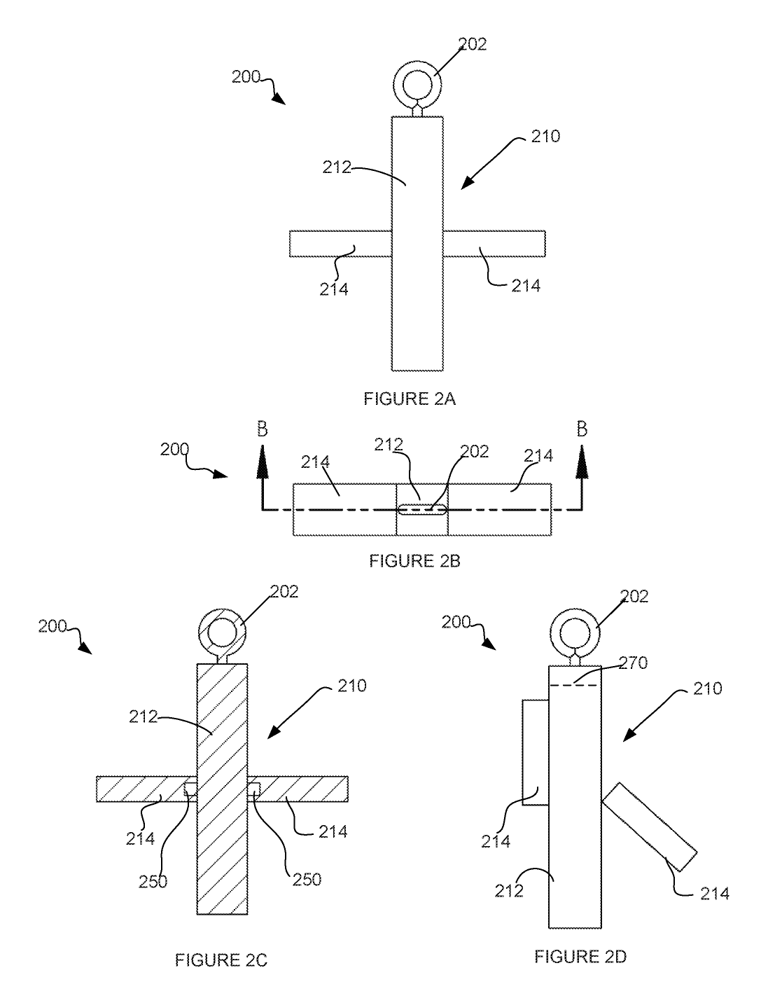

FIG. 2A is a front view of one embodiment of an apparatus 200 for forming a bladder, FIG. 2B is top view of apparatus 200, FIG. 2C is a cross-sectional view of apparatus 200 along plane B-B of FIG. 2B and FIG. 2D illustrates one embodiment of disassembling apparatus 200 (FIGS. 2A-2D are collectively referred to as FIG. 2).

As illustrated, the apparatus 200 includes a hanging feature 202, such as a ring or other feature for hanging the respective apparatus 200 to dry, coupled to a multi-piece mandrel 210. Mandrel 210 comprises a base 212 formed of one or more parts. Base 212 is adapted to form a center portion of a bladder and a bladder opening. Secondary mandrel pieces 214 (e.g., arms) are removably coupled to base 212 to form a complex mandrel shape (a shape that requires the mandrel to reconfigured so that the mandrel can be removed from the bladder without damaging or rendering the bladder unusable).

According to one embodiment, base 212 is formed of a magnetic material and secondary mandrel pieces 214 contain magnets 250 located proximate to a face of the secondary mandrel pieces 214. In other embodiments, secondary mandrel pieces 214 may be formed of magnetic material and base 212 may contain magnets and/or both base 212 and secondary mandrel pieces 214 may contain magnets. In this embodiment, the position of secondary mandrel pieces 214 relative to a base 212 or other secondary mandrel piece may be adjusted such that the same mandrel 210 can be used to form multiple shapes.

In operation, mandrel 210 can be dipped into a liquid tank (e.g., containing latex, neoprene or other material suitable for forming bladders used in composite part molding) with the top portion of base 212 remaining unsubmerged. For example, mandrel 210 may be dipped to approximately 270. When mandrel 210 is removed, the residual bladder material dries to form a flexible bladder.

After dipping, secondary mandrel pieces 214 will be located below the bladder opening—that is, within the bladder. At some point after dipping, such as when the bladder is fully or otherwise sufficiently cured on mandrel 210 to allow removal, secondary mandrel pieces 214 may be pulled apart from base 212 with a small amount of lateral movement and base 212 removed from the bladder, leaving an opening in the bladder (e.g., such as opening 126 indicated in FIG. 1). The secondary mandrel pieces 214 are then manipulated to remove them through the bladder opening left by base 212. Alternatively, if the flexibility of the bladder material allows, the secondary mandrel pieces 214 may be removed from the opening prior to removing base 212. Mandrel 210 may be reassembled to dip another bladder.

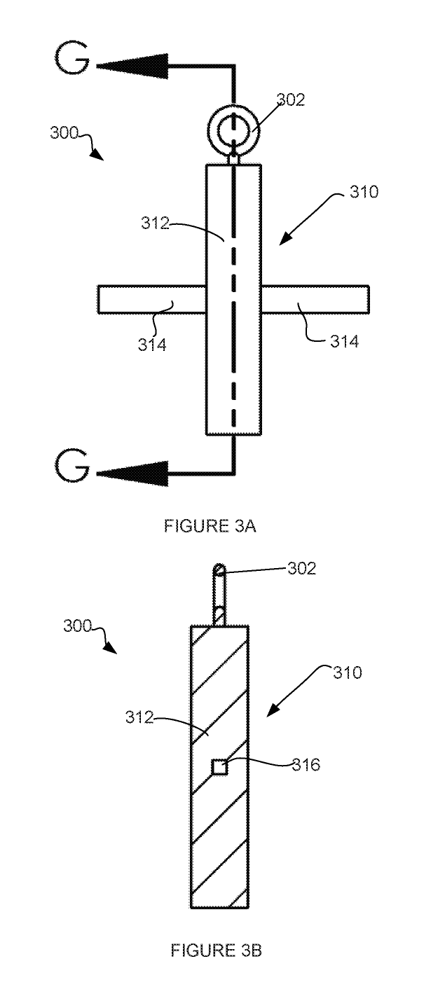

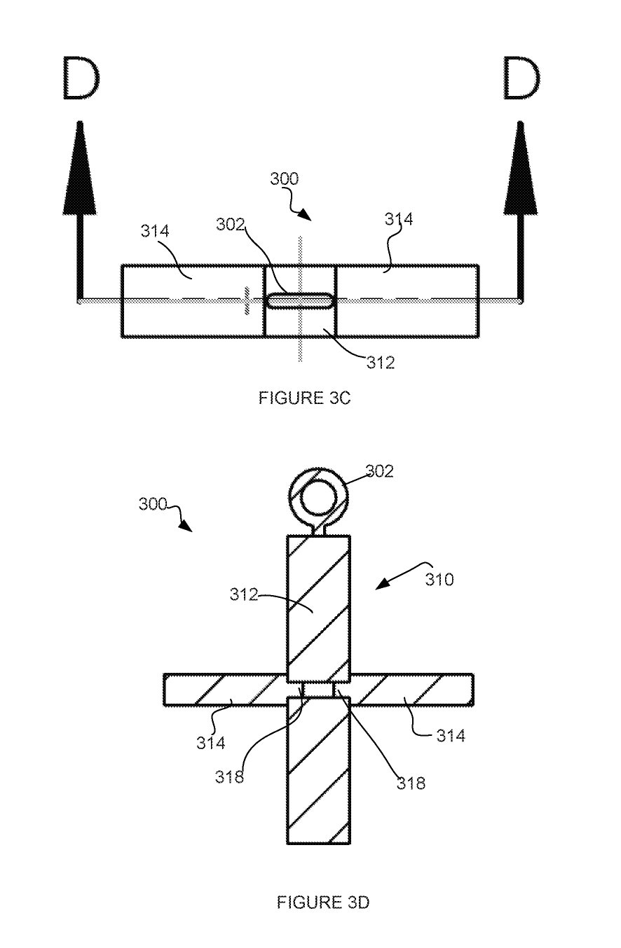

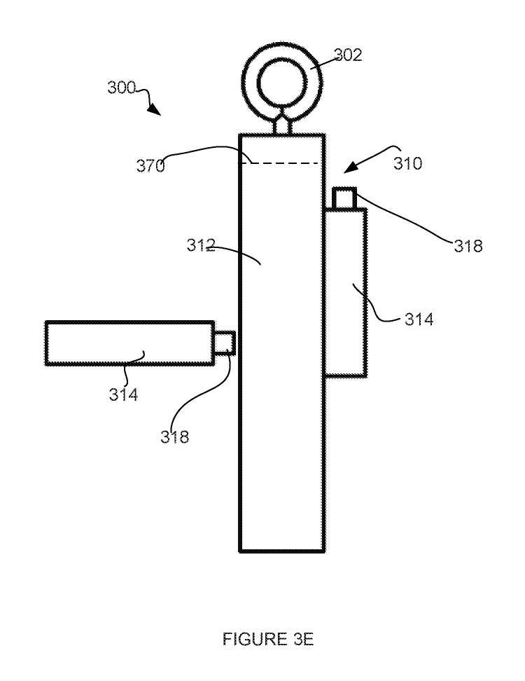

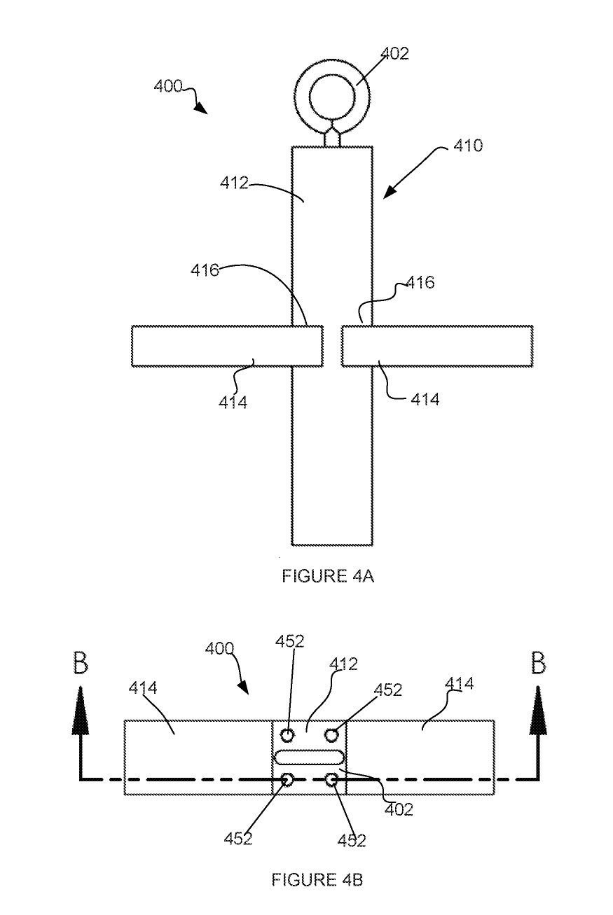

FIG. 3A is a front view of one embodiment of an apparatus 300 for shaping a bladder, FIG. 3B is a cross-section of apparatus 300 along plane G-G of FIG. 3A, FIG. 3C is top view of apparatus 300, FIG. 3D is a cross-sectional view of apparatus 300 along plane D-D of FIG. 3C and FIG. 3E illustrates one embodiment of disassembling apparatus 300 (FIGS. 3A-3E are collectively referred to as FIG. 3).

As illustrated, the apparatus 300 includes a hanging feature 302, such as a ring or other feature for hanging the respective apparatus 300 to dry, coupled to a multi-piece mandrel 310. Mandrel 310 comprises a base 312 formed of one or more parts. Base 312 is adapted to form a center portion of a bladder and a bladder opening. Secondary mandrel pieces 314 (e.g., arms) are removably coupled to base 312 to form a complex mandrel shape.

In accordance with one embodiment, two or more mandrel pieces may be connected using a mortise-tenon joint or other geometry features. In the embodiment of FIG. 3, the base 312 includes an opening 316 into which a male geometry 318 on the secondary mandrel pieces 314 may be inserted. The opening 316 and male features 318 may create a friction fit. In some embodiments, base 312 or secondary mandrel pieces 314 may include geometries so that the secondary mandrel piece may be placed in one of a plurality of selectable positions relative to the base or another secondary mandrel piece. Thus, in some embodiments, a single mandrel 310 may be used to create a variety of shapes through geometry features.

In operation, mandrel 310 can be dipped into a liquid tank (e.g., containing latex, neoprene or other material suitable for forming bladders used in composite part molding) with the top portion of base 312 remaining unsubmerged. For example, mandrel 310 may be dipped to approximately 370. When mandrel 310 is removed from the liquid tank, the residual bladder material dries to form a flexible bladder.

After dipping, secondary mandrel pieces 314 will be located below the bladder opening—that is, within the bladder. At some point after dipping, such as when the bladder is fully or otherwise sufficiently cured on mandrel 310 to allow removal, secondary mandrel pieces 314 may be pulled apart from base 312 with a small amount of lateral movement and base 312 removed from the bladder leaving the bladder opening. Secondary mandrel pieces 314 may then be manipulated out of the bladder opening left by base 312. Alternatively, if the flexibility of the bladder material allows, the secondary mandrel pieces 314 may be removed from the opening prior to removing base 312. For example, a secondary mandrel piece 314 may be pulled out of base 312 and slid out the top hole of the bladder prior to removing base 312.

A variety of other configurations of geometry features can be used to removably hold secondary mandrel pieces 314 to base 312. For example, each of the secondary mandrel pieces 314 may include an opening on one end into which a male feature of base 312 can fit. In another embodiment, secondary mandrel pieces 314 or base 312 may include keyed features such that the secondary mandrel pieces can only be coupled to and pulled apart from base 312 in a specific orientation(s). In any event, the base 312 and secondary mandrel pieces can be adapted to allow reassembly of mandrel 310 for use in forming additional bladders.

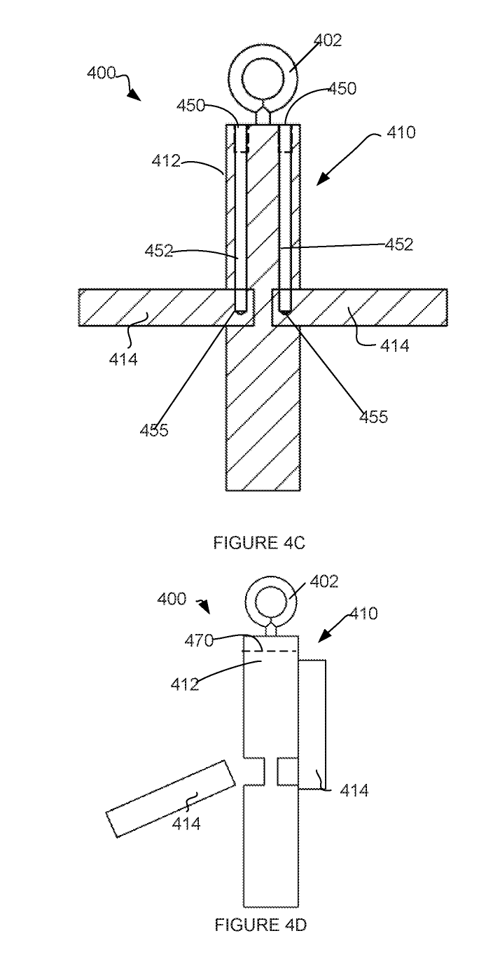

FIG. 4A is a front view of one embodiment of an apparatus 400 for shaping a bladder, FIG. 4B is a top view of apparatus 400, FIG. 4C is a cross-sectional view of apparatus 400 along plane B-B of FIG. 4B and FIG. 4D illustrates one embodiment of disassembling apparatus 400 (FIGS. 4A-4D are collectively referred to as FIG. 4).

As illustrated, the apparatus 400 includes a hanging feature 402, such as a ring or other feature for hanging the respective apparatus 400 to dry, coupled to a multi-piece mandrel 410. Mandrel 410 comprises a base 412 formed of one or more parts. Base 412 is adapted to form a center portion of a bladder and a bladder opening. The sides of base 412 includes recesses 416 to receive the ends of secondary mandrel pieces 414, which are removably coupled to base 412 to form a complex mandrel shape.

In accordance with one embodiment, two or more mandrel pieces may be connected using a releasable locking device, such as a releasable mechanical fastener. In the embodiment of FIG. 4, base 412 includes openings 450 running from an entrance that is positioned to be outside of the bladder or accessible through the opening of the bladder when the bladder is formed on mandrel 410. The openings may run to and connect with complementary openings 455 in the secondary mandrel pieces 414 that align with openings 450 in base 412. A mechanical fastener 452, such as a bolt or other fastener, may be disposed in each opening 450 and extend into the corresponding opening 455 to couple mandrel 410 together. In some embodiments, mandrel 410 may include a mechanism to prevent removal of the fastener until a threshold amount of force is applied. As one example, all or a portion of an opening 450 or corresponding opening 455 may be threaded to hold the fastener 460 in place until a sufficient amount of torque is applied.

Base 412 or secondary mandrel piece 414 may include openings or other features so that the secondary mandrel piece may be secured in one of a plurality of selectable positions relative to the base or another secondary mandrel piece. Thus, the same mandrel 410 may be used to create a plurality of shapes.

In operation, mandrel 410 can be dipped into a liquid tank (e.g., containing latex, neoprene or other material suitable for forming bladders used in composite part molding) with the top portion of base 412 remaining unsubmerged. For example, mandrel 410 may be dipped to approximately 470. When mandrel 410 is removed from the liquid tank, the residual bladder material dries to form a flexible bladder.

After dipping, secondary mandrel pieces 414 will be located below the bladder opening—that is, within the bladder. At some point after dipping, such as when the bladder is fully or otherwise sufficiently cured on mandrel 410 to allow removal, fasteners 452 can be retracted from openings 455 to release secondary mandrel pieces 414 such that secondary mandrel pieces 414 may be pulled apart from base 412 with a small amount of lateral movement. Base 412 can then be removed from the bladder leaving an opening in the bladder. Secondary mandrel pieces 414 are removed by manipulating secondary mandrel pieces 414 out of the bladder opening left by base 412. Alternatively, if the flexibility of the bladder material allows, the secondary mandrel pieces 414 may be removed from the opening prior to removing base 412. Mandrel 410 may then be reassembled to dip another bladder.

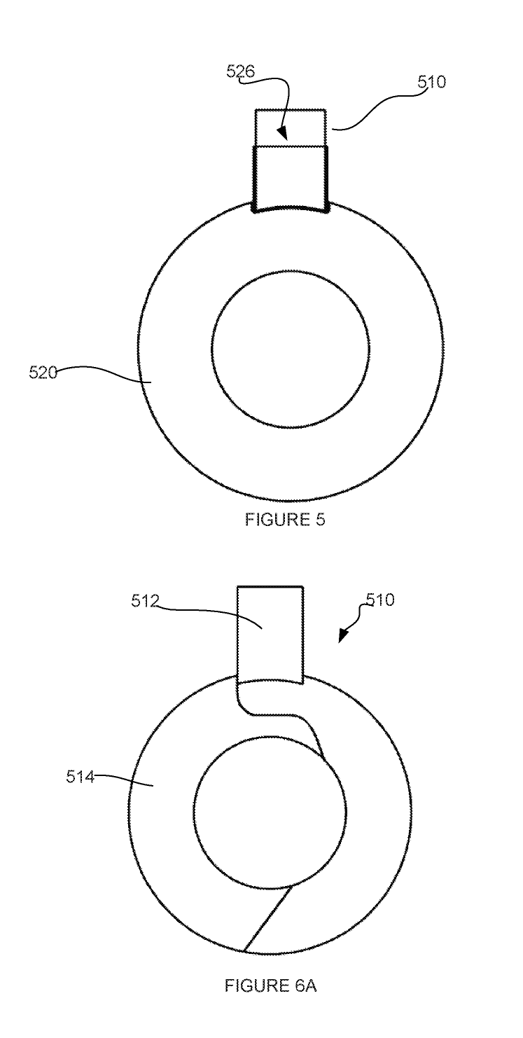

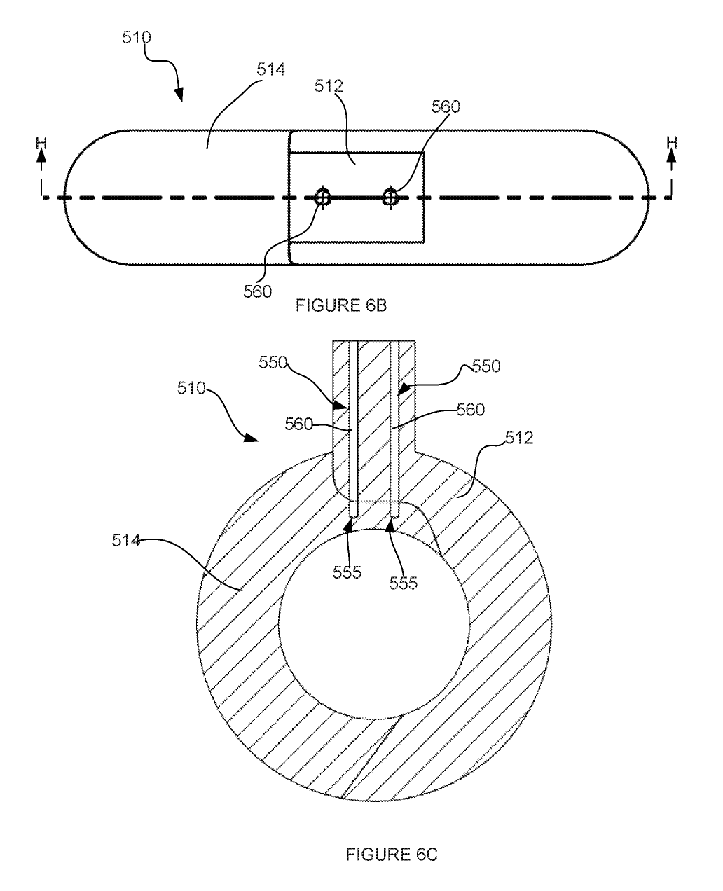

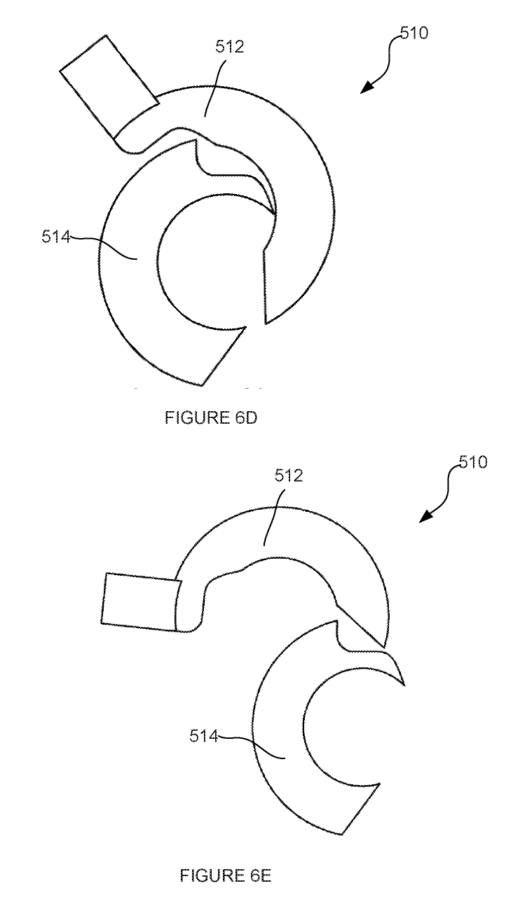

While FIGS. 1-4 illustrate generally “t” or cross-shaped mandrels, mandrels may also have a variety of other complex shapes. FIG. 5, for example, illustrates one embodiment of a mandrel 510 adapted for shaping a bladder 520 having an enclosed loop. Mandrel 510 can be removed through bladder opening formed at 526 with damaging bladder 520. Although not shown, mandrel 510 may be coupled to a hanging feature (e.g., a ring or other hanging feature). FIG. 6A illustrates a front view of one embodiment of mandrel 510, FIG. 6B illustrates a top view of mandrel 510, FIG. 6C illustrates a cross-sectional view of mandrel 510 along plane H-H of FIG. 6B, FIG. 6D illustrates mandrel 510 being disassembled and FIG. 6E illustrates mandrel 510 being further disassembled (FIGS. 6A-6E are referred to collectively as FIG. 6).

Mandrel 510 comprises a base 512 comprises one or more pieces adapted to form the bladder opening 526 and a portion of the loop. One or more secondary pieces are coupled to base 512 or other secondary pieces to complete the loop. In the illustrated embodiment, for example, secondary mandrel piece 514 is removably coupled to base 512 to form the loop.

Mandrel pieces may be coupled to each other to form the loop using magnetic force, geometric features, mechanical fasteners or other mechanism. In the embodiment illustrated, base 512 includes openings 550 running from entrances that are positioned to be outside of the bladder 520 or accessible through the opening of the bladder 520 when the bladder 520 is formed on mandrel 510 (e.g., on an outer surface of base 512) and secondary mandrel piece 514 includes a portion having openings 555 that are adapted to align with openings 550 such that the openings 550 run to and connect with complementary openings 555 in a secondary mandrel piece 514. A mechanical fastener 560, such as a bolt or other fastener, may be disposed in each opening 550 and extend into the corresponding opening 555 to properly align secondary mandrel piece 514 with base 512 and prevent secondary mandrel piece 514 from being removed from mandrel 510. In some embodiments, mandrel 510 may include a mechanism to prevent removal of the fastener until a threshold amount of force is applied. As one example, all or a portion of an opening 550 or corresponding opening 555 may be threaded to hold the fastener 560 in place until a sufficient amount of torque is applied. In some embodiments, the base 512 or secondary mandrel piece 514 may include openings or other features so that the secondary mandrel piece may be secured in one of a plurality of selectable positions relative to the base or another secondary mandrel piece. Thus, the same mandrel may be used to create a plurality of shapes.

With reference to FIG. 5 and FIG. 6, mandrel 510 can be dipped into a liquid tank (e.g., containing latex, neoprene or other material suitable for forming bladders used in composite part molding) with the top portion of base 512 remaining unsubmerged. When mandrel 510 is removed from the liquid tank, the residual bladder material dries to form a flexible bladder 520.

After dipping, secondary mandrel piece 514 will be located below the bladder opening 526—that is, within the bladder 520. At some point after dipping, such as when the bladder is fully or otherwise sufficiently cured on mandrel 510 to allow removal, fasteners 560 can be retracted to release secondary mandrel piece 514 so that base 512 and secondary mandrel piece 514 can be pulled apart and manipulated (e.g., as illustrated in FIG. 6D and FIG. 6E). Base 514 and secondary mandrel piece 514 may be pulled apart and base 512 removed from the bladder leaving an opening 526 in the bladder 520. Secondary mandrel piece 514 may then be manipulated out of the bladder opening left by base 512. Alternatively, if the flexibility of the bladder material allows, the secondary mandrel pieces 514 may be removed from the opening prior to removing base 512. Mandrel 510 may be reassembled to dip another bladder.

While FIG. 6 illustrates base 512 and secondary mandrel piece 514 coupled using mechanical fasteners 560, base 512 and secondary mandrel piece 514 may be coupled using other releasable holding mechanisms such as magnets, geometries or other releasable holding features. Moreover, while FIG. 6 illustrates that mandrel 510 comprises a loop formed of two pieces, other embodiments of mandrels may form loops using more than two mandrel pieces, for example, using additional secondary mandrel pieces.

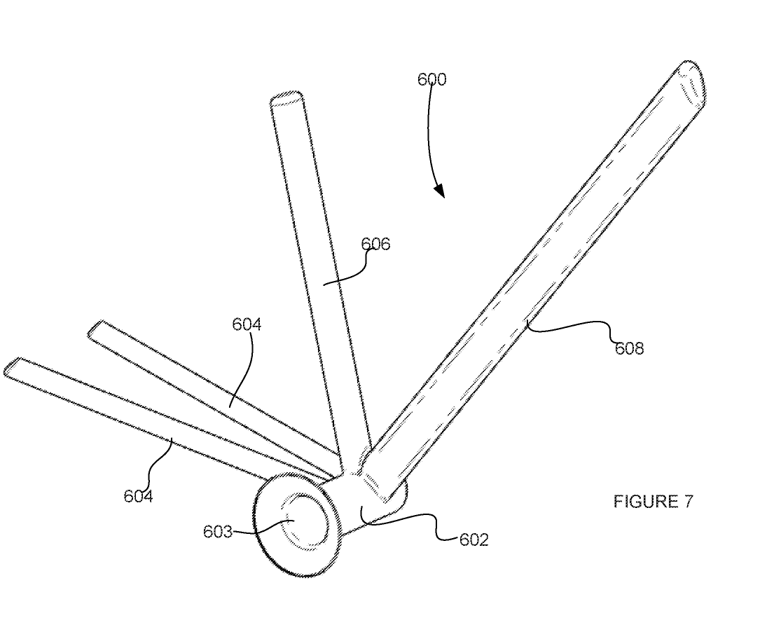

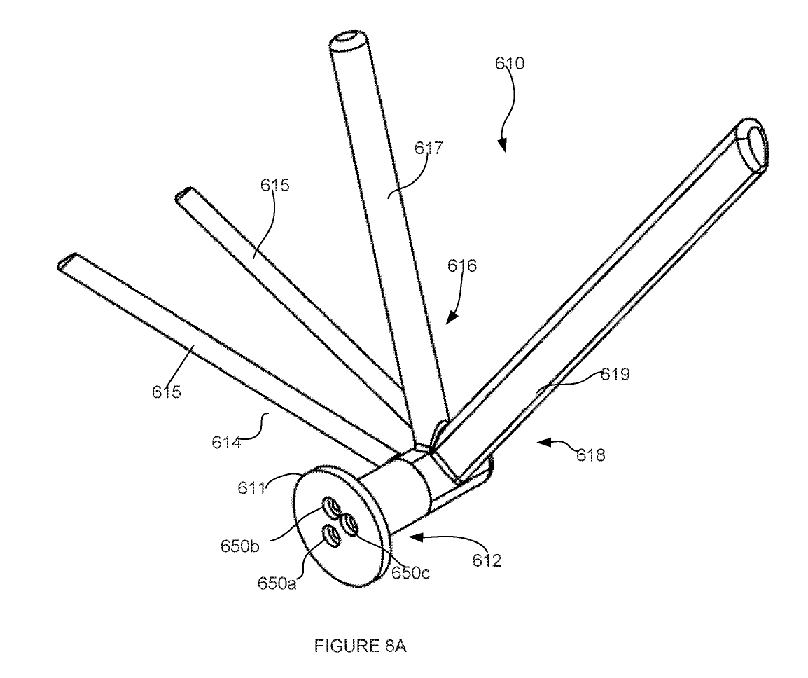

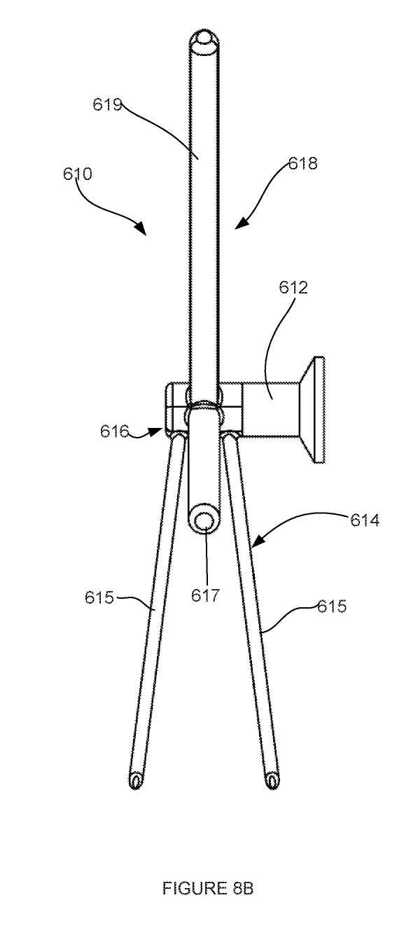

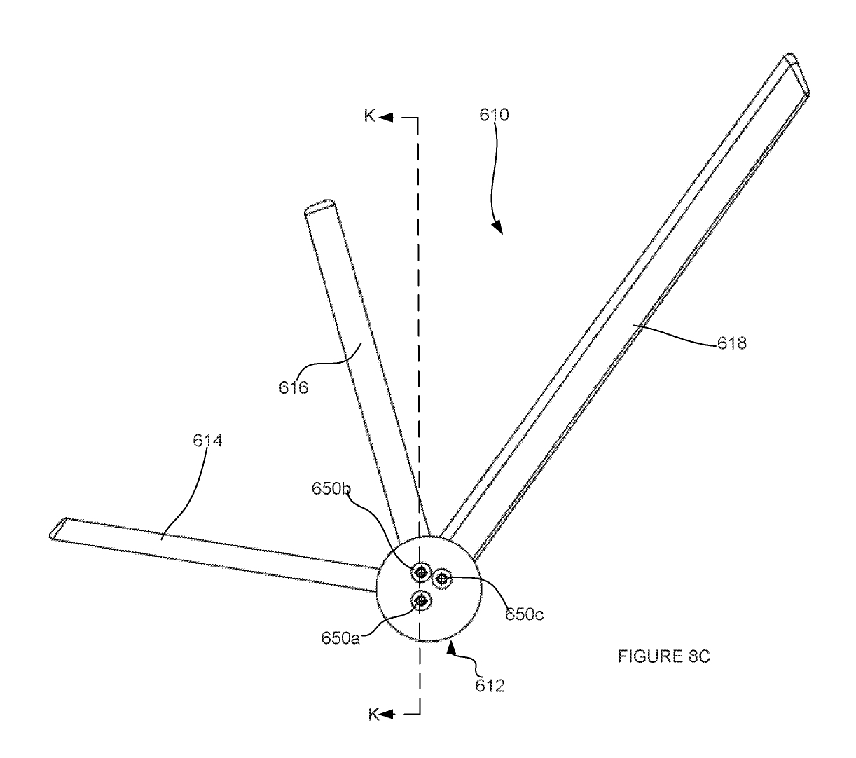

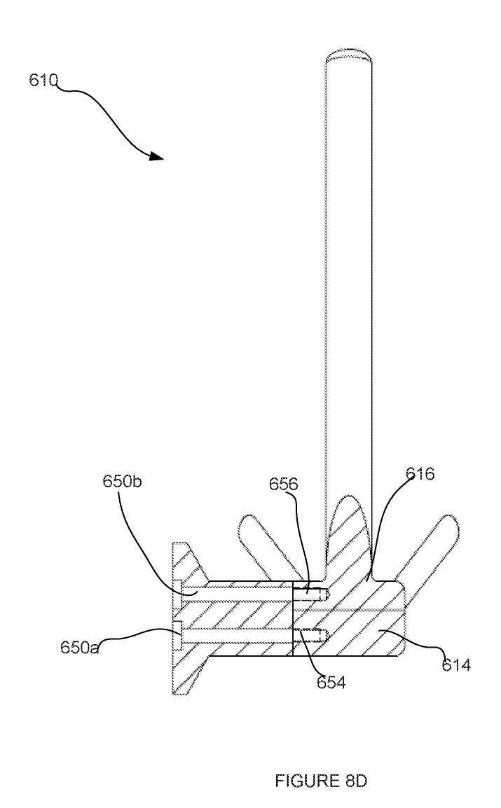

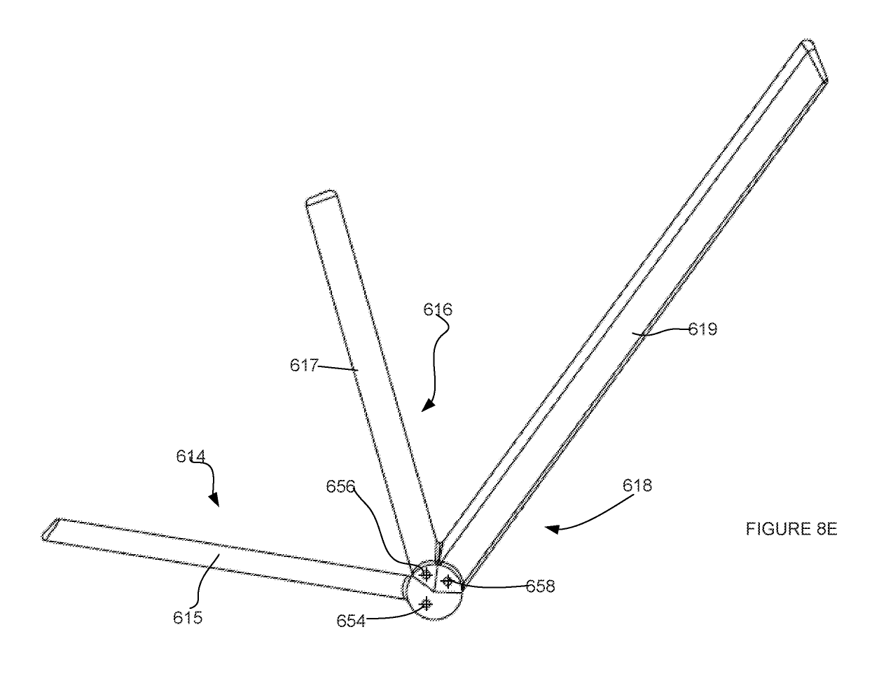

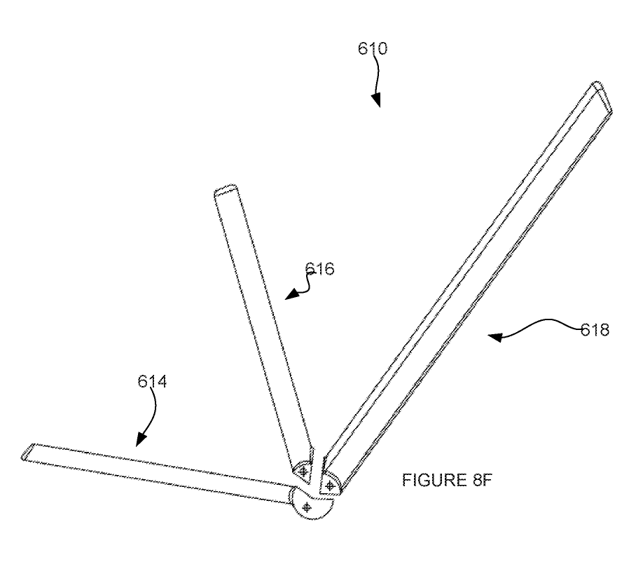

Mandrels as described herein may be used to form flexible bladders in a variety of complex shapes. FIG. 7, for example, illustrates one embodiment of a bladder 600 for molding a portion of a composite bicycle frame. Bladder 600 has a bicycle frame shape—that is a shape for molding a portion of a bicycle frame or a complete bicycle frame—and includes a portion 602 for molding a bicycle frame lower bracket, portions 604 for molding stays (e.g., chain stays), portion 606 for molding a seat tube and portion 608 for molding a downtube. FIG. 8A illustrates a first view of a mandrel 610 that can be used to form bladder 600, FIG. 8B illustrates a second view of mandrel 610, FIG. 8C illustrates a third view of mandrel 610, FIG. 8D illustrates a cross-sectional view of mandrel 610 in place K-K of FIG. 8C, FIG. 8E illustrates one embodiment mandrel 610 in a first state of disassembly and FIG. 8F illustrates one embodiment of mandrel 610 in a second state of disassembly. FIGS. 8A-8F are referred to collectively as FIG. 8.

Mandrel 610 comprises a mandrel base 612 and secondary mandrel pieces 614, 616, 618 coupled together to form a bicycle frame shape having portion corresponding various frame members of a bicycle frame. Base 612 is adapted to form the bladder opening 603 and may be coupled to a hanging feature or other feature so that mandrel can be hung with portion 611 up. Secondary piece 614 includes protrusions 615 adapted to form the stay portion 604 of bladder 600, secondary piece 616 includes protrusion 617 adapted to form the seat tube portion 606 of bladder 600 and secondary piece 618 includes 619 adapted to form the downtube portion 608 of bladder 600.

Base 612 includes fastener openings 650a, 650b and 650c that pass through base 612 from entrances positioned to be outside of bladder 600 or be accessible through bladder opening 603 when bladder 600 is formed on mandrel 610. Each of secondary mandrel pieces 614, 616, 618 overlaps base 612 so that fastener openings through base 612 may run to and connect with complementary fastener openings in the secondary mandrel pieces. As illustrated in FIG. 8D, for example, opening 650a runs to and connects with opening 654 in secondary piece 614 and opening 650b runs to and connects with opening 656 in secondary mandrel piece 616. Further, secondary mandrel piece 618 includes opening 658 (shown in FIG. 8E) that aligns with fastener opening 650c.

Mechanical fasteners, such as bolts or other fasteners, may be disposed in openings 650a, 650b, 650c and extend into openings 654, 656, 658 to hold mandrel 610 together during dipping of mandrel 610 and curing of bladder 620. In some embodiments, mandrel 610 may include a mechanism to prevent removal of a fastener until a threshold amount of force is applied. As one example, all or a portion of an opening 650a, 650b, 650c, 654, 656, 658 may be threaded to hold a fastener in place until a sufficient amount of torque is applied.

In some cases, a fastener opening in a secondary mandrel piece may form an intermediate portion of an opening. For example, a portion of one secondary mandrel piece may overlap a portion of another secondary mandrel piece and the overlapping portions may include fastener openings that align. Thus, a fastener may pass through the base, through one or more intermediate secondary mandrel pieces and terminate in a fastener opening in another secondary mandrel piece.

In operation, mandrel 610 can be dipped into a liquid tank (e.g., containing latex, neoprene or other material suitable for forming bladders used in composite part molding) with the top portion 611 of base 612 remaining unsubmerged. When mandrel 610 is removed from the liquid tank, the residual bladder material dries to form a flexible bladder.

After dipping, secondary mandrel pieces 614, 616 and 618 will be located within the bladder 600. At some point after dipping, such as when the bladder 600 is fully or otherwise sufficiently cured on mandrel 610 to allow removal, the fasteners can be retracted to release secondary mandrel pieces 614, 616, 618 from base 612. Base 612 can be removed from the bladder 620 leaving an opening 603 in the bladder. FIG. 8E illustrates mandrel 610 with base 612 removed (bladder not illustrated in FIG. 8E). The secondary mandrel pieces may then be pulled apart. FIG. 8F illustrates mandrel pieces 614, 616, 618 pulled apart (the bladder is not illustrated in FIG. 8F). Secondary mandrel piece 614 may then be manipulated out of the bladder opening 603 left by base 612. Next, secondary mandrel piece 616 is manipulated out of bladder opening 603, followed by mandrel piece 618.

While, in the illustrated example of FIG. 8, base 612 and secondary mandrel pieces 614, 616, 618 are coupled using mechanical fasteners, base 612 and secondary mandrel pieces 614, 616, 618 may be coupled using other releasable holding mechanisms such as magnets, geometries, biased (e.g., spring-loaded) pins or detents, or other releasable holding features.

It can be noted that, when mandrels 210, 310, 410, 510, 610 are assembled, the mandrels may have an extreme protrusion or other feature that prevents removal of the mandrel in a first configuration (e.g., an assembled configuration) without damaging the respective bladder. Unlike a one-piece mandrel, mandrels 210, 310, 410, 510, 610 may be disassembled within a bladder. In particular, secondary mandrel pieces 214, 314, 414, 514, 614, 616, 618 are removable from respective bases 212, 312, 412, 512, 612, in some cases with a relatively small amount of movement. The mandrel pieces of mandrels 210, 310, 410, 510, 610 (e.g., bases 212, 312, 412, 512, 612 and removable secondary mandrel pieces 214, 314, 414, 514, 614, 616, 618) are adapted to be removable from the bladder without damaging the bladder. That is, the mandrel pieces are adapted to manipulated within in the bladder and fit through the bladder opening, in some cases, when manipulated in a particular sequence, without damaging the bladder.

According to one embodiment, the size and shape of secondary mandrel pieces 214, 314, 414, 514, 614, 616, 618 and the amount of movement required to remove secondary mandrel pieces 214, 314, 414, 514, 614, 616, 618 can be selected to be within the stretchability of the bladder such that the secondary mandrel pieces can be removed without damaging the bladder. According to one embodiment, mandrels 210, 310, 410, 510, 610 provide examples of reusable, below yield strength mandrels. The amount of movement required to disassemble the mandrel in the bladder and the outer cross-section of each mandrel piece along at least one axis of the mandrel piece can be selected so that disassembly and removal of the mandrel remains within the elastic range of the respective bladder such that the mandrel pieces may be removed without damaging the bladder. For example, according to one embodiment, the base may be configured with a molding surface to form a bladder opening having a first cross-sectional area and each secondary mandrel piece may have an outer-cross section along at least one axis or length that has an area that is less than cross-section of the bladder opening. Further, the mandrel pieces may be shaped to achieve a desired fitment between the pieces such that the pieces are removable from the bladder and avoid sharp edges that may cut the bladder. The shapes of the mandrel pieces may be selected to for ease of machinability.

While FIGS. 2-8 illustrate the secondary mandrel pieces coupled to the respective bases using particular mechanisms, the secondary mandrel pieces may be coupled to the base or other mandrel piece using magnets, mechanical fasteners, geometries, biased (e.g., spring loaded) pins or detents or other releasable holding mechanisms or combinations thereof.

In the foregoing examples, the secondary mandrel pieces are coupled directly to the base. In other embodiments, some secondary mandrel pieces may be removably coupled to other secondary mandrel pieces. For example, a secondary mandrel piece 214, 314, 414, 514, 614, 616, 618 may comprise multiple pieces coupled together by magnets or other releasable holding mechanism.

Mandrel pieces may be formed of metal, wood, foam or other material or combinations of materials. The mandrel pieces may be solid or include hollow cores. As can be understood from the foregoing, reusable, removable mandrels can be used to produce bladders formed from materials suitable for use in composite part molding (e.g., latex, neoprene and other bladder materials used in fibre glass, carbon fiber and other composite material molding processes) where the bladders have complex shapes that cannot be achieved using a single piece, reusable mandrel.

One embodiment of an apparatus for forming flexible bladders adapted for use in molding a composite part may comprise a removable, reusable mandrel. The reusable mandrel may comprise a base adapted to form an opening in a flexible bladder and a secondary mandrel piece releasably coupled to the base, wherein the mandrel adapted to allow disassembly of the mandrel and removal of the mandrel from the bladder. In one embodiment, the mandrel may be a below yield strength mandrel for forming latex or neoprene bladders.

Although the invention has been described in particular detail with respect to a limited number of embodiments thereof, the description herein of specific embodiments of the invention. Rather, the description is intended to describe illustrative embodiments, features and functions in order to provide a person of ordinary skill in the art context to understand the invention without limiting the invention to any particularly described embodiment, feature or function.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the otherwise. Also, as used in the description herein, the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. Moreover, those of skill in the art will appreciate that in some instances some features of embodiments of the invention will be employed without a corresponding use of other features without departing from the scope and spirit of the invention as set forth. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although specific embodiments have been described, these embodiments are merely illustrative, and not restrictive of the invention. The description herein of illustrated embodiments of the invention is not intended to be exhaustive or to limit the invention to the precise forms disclosed herein. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention. Any dimensions provided are provided by way of example and other embodiments may be sized as needed or desired.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A reusable mandrel for forming flexible composite molding bladders, the mandrel comprising:
a base adapted to form a bladder opening; and
a secondary mandrel piece removably coupled to the base to form a complex mandrel shape, the at least one secondary mandrel piece adapted to be removable from the base when within a bladder formed on the mandrel to allow the base and the secondary mandrel piece to be removed from the bladder through the bladder opening without damaging the bladder, wherein the reusable mandrel is configurable in a non-removable configuration and a removable configuration.

2. The reusable mandrel of claim 1, wherein the complex mandrel shape comprises an extreme protrusion.

3. The reusable mandrel of claim 1, wherein the complex mandrel shape comprises an enclosed loop.

4. The reusable mandrel of claim 1, wherein base and the secondary mandrel piece form a below yield strength mandrel body.

5. The reusable mandrel of claim 1, wherein the secondary mandrel piece is removably attached to the base by a magnet.

6. The reusable mandrel of claim 1, wherein the base defines a first fastener opening and the secondary mandrel piece defines a second fastener opening aligned with the first fastener opening and wherein the mandrel further comprises a mechanical fastener running from the first fastener opening to the second fastener opening.

7. The reusable mandrel of claim 1, wherein the complex mandrel shape comprises a bicycle frame shape comprising protrusions extending in multiple directions.

8. A method of forming a flexible composite molding bladder comprising:
dipping a reusable mandrel in a bladder material, the reusable mandrel comprising a base adapted to form a bladder opening a secondary mandrel piece coupled to the base to form a complex mandrel shape;
at least partially curing the bladder material to form a first flexible bladder on the mandrel;
reconfiguring the reusable mandrel from a non-removable configuration to a removable configuration, wherein reconfiguring the reusable mandrel comprises removing the secondary mandrel piece from the base while the secondary mandrel piece is within the first flexible bladder formed on the mandrel;
removing the base and the secondary mandrel piece from the first flexible bladder; and
reassembling the first mandrel for reuse to form another flexible composite molding bladder.

9. The method of claim 8, wherein the complex mandrel shape comprises an extreme protrusion.

10. The method of claim 8, wherein the complex mandrel shape comprises an enclosed loop.

11. The method of claim 8, wherein the reusable mandrel has a below yield strength mandrel body.

12. The method of claim 8, wherein removing the secondary mandrel piece from the base while the secondary mandrel piece is within the first flexible bladder formed on the mandrel comprises manipulating the secondary mandrel piece to overcome a magnetic force.

13. The method of claim 8, wherein removing the secondary mandrel piece from the base while the secondary mandrel piece is within the first flexible bladder formed on the mandrel comprises manipulating a mechanical fastener from outside of the first flexible bladder to release the secondary mandrel piece from the base.

14. The method of claim 8, wherein at least partially curing the bladder material to form a first flexible bladder on the mandrel comprising forming a first flexible bladder having a bicycle frame shape.
